(19) United States
(12) Patent Application Publication
(10) Pub. No.: US 2026/0265133 A1
(43) Pub. Date: Sep. 10, 2026

(54) COMPOSITIONS AND METHODS OF MAKING CEMENTITIOUS BINDERS

(71) Applicant: C-CRETE TECHNOLOGIES LLC, San Leandro, CA (US)

(72) Inventors: Rouzbeh SAVARY, San Leandro, CA (US); Sanan EMINOV, San Leandro, CA (US)

(21) Appl. No.: 19/167,581

(22) PCT Filed: Mar. 20, 2024
(86) PCT No.: PCT/US2024/020709

§ 371 Date: Sep. 22, 2025

Related U.S. Application Data
(60) Provisional application No. 63/453,437, filed on Mar. 20, 2023.

(51) Int. Cl. C04B 14/30; C04B 22/00; C04B 40/00; C04B 40/02; C04B 103/10; C04B 103/54

(52) U.S. Cl. CPC C04B 14/308; C04B 14/307; C04B 22/00; C04B 40/0028; C04B 40/0263; C04B 2103/10; C04B 2103/54; C04B 2201/50

(57) ABSTRACT

The present disclosure describes compositions for cementitious materials and methods for making the same. The cementitious materials may be chemically activated concrete materials that utilize industrial byproducts and/or natural material, which may offer an environmentally friendly alternative to Portland cement and other traditional cement materials, lire cementitious materials may replace Portland, cement or be added to Portland cement to form construction materials.

### CROSS-REFERENCE TO RELATED APPLICATIONS

This application claims the benefit of U.S. Provisional Patent Application No. 63/453,437 filed Mar. 20, 2023, the entirety of which is incorporated by reference herein.

### FIELD

The present disclosure relates to compositions for chemically activated cementitious materials and methods for making the same.

### BACKGROUND

Cementitious materials are crucial components in building materials and other industries. One of the most common cementitious materials is Portland cement. Despite its widespread use, there are environmental concerns surrounding Portland cement, including the emission of greenhouse gases and significant energy requirements incurred during production. Accordingly, there is a desire to provide cementitious materials that have a lessened environmental footprint.

One such material is chemically activated cementitious material, which may be considered an alternative to Portland cement. Chemically activated cementitious material may include industrial byproducts or natural materials which contain aluminosilicates such as slag, fly ash, ash from wastes, clay, natural pozzolans, granite, basalt, or zeolite and represents an opportunity to develop green construction materials. Ideally, an alternative material offers equivalent strength and durability to Portland cement while requiring a smaller energy cost. However, currently available chemically activated materials suffer from poor workability and limited strength. It is thus advantageous and there is a need to develop compositions for chemically activated cementitious materials which possess improved strength, durability, and other desirable properties.

### SUMMARY

In some aspects, the techniques described herein relate to a cementitious material, including: one or more chemical activators and industrial byproducts or natural material, wherein the activator(s) includes one or more of potassium silicates, potassium carbonate, potassium phosphate, potassium bicarbonate, potassium nitrate, potassium hydroxide, potassium oxide, potassium sulfate, sodium silicates, sodium carbonate, sodium phosphate, sodium bicarbonate, sodium nitrate, sodium hydroxide, sodium oxide, sodium sulfate, calcium nitrate, calcium silicates, calcium hydroxide, calcium oxide, calcium aluminates, calcium sulfate, calcium aluminum silicates, calcium silicate hydrates, calcium aluminum silicate hydrates or combinations thereof, and wherein the industrial byproduct or natural materials includes ferrous slag, non-ferrous slag, converter steel slag, air-cooled slag, Solvay phosphorous slag, bauxite slag/residue, zinc slag, lead slag, electric arc furnace (EAF) slag, granulated, blast fumace slag, ladle slag, copper slag, mine tales, zeolites, clay, volcanic lava, volcanic tuffs, metakaolin, calcined shale, silica fume gauze, biomass ash, halloysite, calcined clay, basalt, granite, pumice, natural pozzolans, bottom ash, fly ash, cement kiln dust, fine waste glass powder derived from waste glass, mining waste (for example, Belterra clay), a finely ground waste concrete powder derived from construction and demolition waste, or rubble, and EAF dust together with lime kiln dust, municipal solid waste incineration ash, limestone, marble, gabbro, or any combinations thereof.

In some aspects, the techniques described herein relate to a cementitious material, further including one or more of sand, gravel, pH regulating admixtures, curing enhancers, agglomeration reducers, set retarders, strength enhancers, corrosion inhibitors, shrinkage reducers, crack reducers, viscosity reducers, superplasticizers, air entrainments, or combinations thereof.

In some aspects, the techniques described herein relate to a cementitious material, wherein the cementitious material includes less than about 30 wt. % chemical activators.

In some aspects, the techniques described herein relate to a cementitious material, wherein the cementitious material includes less than about 15 wt. % chemical activators.

In some aspects, the techniques described herein relate to a cementitious material, wherein the cementitious material includes less than about 10 wt. % chemical activators.

In some aspects, the techniques described herein relate to a cementitious material, wherein the cementitious material includes less than about 5 wt. % chemical activators.

In some aspects, the techniques described herein relate to a method of making a cementitious material, including: combining a chemical activator and an industrial byproduct and/or natural material with water to form a cementitious material, wherein the chemical activator includes potassium silicates, potassium carbonate, potassium phosphate, potassium bicarbonate, potassium nitrate, potassium hydroxide, potassium oxide, potassium sulfate, sodium silicates, sodium carbonate, sodium phosphate, sodium bicarbonate, sodium nitrate, sodium hydroxide, sodium oxide, sodium sulfate, calcium nitrate, calcium silicates, calcium hydroxide, calcium oxide, calcium aluminates, calcium sulfate, calcium aluminum silicates, calcium silicate hydrates, calcium aluminum silicate hydrates or combinations thereof, and wherein the industrial byproduct or natural material includes ferrous slag, non-ferrous slag, converter steel slag, air-cooled slag, Solvay phosphorous slag, bauxite slag or bauxite residue, zinc slag, lead slag, electric arc furnace (EAF) slag, granulated, blast furnace slag, ladle slag, copper slag, mine tales, zeolites, clay, volcanic lava, volcanic tuffs, metakaolin, calcined shale, silica fume gauze, biomass ash, halloysite, calcined clay, basalt, granite, pumice, natural pozzolans, bottom ash, fly ash, cement kiln dust, fine waste glass powder derived from waste glass, mining waste (for example, Belterra clay), a finely ground waste concrete powder derived from construction and demolition waste, or rubble, and EAF dust together with lime kiln dust, municipal solid waste incineration ash, limestone, marble, gabbro, or combinations thereof.

In some aspects, the techniques described herein relate to a method, wherein the chemical activator and the industrial byproduct and/or natural material are mixed before being combined with water.

In some aspects, the techniques described herein relate to a method, wherein the chemical activator and the industrial byproduct and/or natural material are mixed in a milling machine.

In some aspects, the techniques described herein relate to a method, wherein the chemical activator is dissolved in water before being combined with the industrial byproduct and/or natural material.

In some aspects, the techniques described herein relate to a method, further including adding one or more of sand, gravel, pH regulating admixtures, curing enhancers, agglomeration reducers, set retarders, strength enhancers, corrosion inhibitors, shrinkage reducers, crack reducers, viscosity reducers, superplasticizers, air entrainments, or combinations thereof to the chemical activator and the industrial byproduct and/or natural material.

In some aspects, the techniques described herein relate to a cementitious material including: a chemical activator that includes one or more of potassium silicates, potassium carbonate, potassium phosphate, potassium bicarbonate, potassium nitrate, potassium hydroxide, potassium oxide, potassium sulfate, sodium silicates, sodium carbonate, sodium phosphate, sodium bicarbonate, sodium nitrate, sodium hydroxide, sodium oxide, sodium sulfate, calcium nitrate, calcium silicates, calcium hydroxide, calcium oxide, calcium aluminates, calcium sulfate, calcium aluminum silicates, calcium silicate hydrates, calcium aluminum silicate hydrates; and an industrial byproduct and/or natural material that includes one or more of ferrous slag, non-ferrous slag, converter steel slag, air-cooled slag, Solvay phosphorous slag, bauxite slag/residue, zinc slag, lead slag, electric arc furnace (EAF) slag, granulated, blast furnace slag, ladle slag, copper slag, mine tales, zeolites, clay, volcanic lava, volcanic tuffs, metakaolin, calcined shale, silica fume gaize, biomass ash, halloysite, calcined clay, basalt, granite, pumice, natural pozzolans, bottom ash, fly ash, cement kiln dust, fine waste glass powder derived from waste glass, mining waste (for example, Belterra clay), a finely ground waste concrete powder derived from construction and demolition waste, or rubble, and EAF dust together with lime kiln dust, or municipal solid waste incineration ash.

In some aspects, the techniques described herein relate to a cementitious material, further including one or more of sand, gravel, pH regulating admixtures, curing enhancers, agglomeration reducers, set retarders, strength enhancers, corrosion inhibitors, shrinkage reducers, crack reducers, viscosity reducer, superplasticizers, air entrainments, or combinations thereof.

In some aspects, the techniques described herein relate to a cementitious material, wherein the cementitious material includes less than about 30 wt. % of the chemical activator.

In some aspects, the techniques described herein relate to a cementitious material, wherein the cementitious material includes less than about 15 wt. % of the chemical activator.

In some aspects, the techniques described herein relate to a cementitious material, wherein the cementitious material includes less than about 10 wt. % of the chemical activator.

In some aspects, the techniques described herein relate to a cementitious material, wherein the cementitious material includes less than about 5 wt. % of the chemical activator.

In some aspects, the techniques described herein relate to a cementitious material, further including a pigment admixture in an amount of about 0.1 wt. % to about 3 wt. % of the cementitious material, wherein the pigment admixture contains one or more of red iron oxide, black iron oxide, chromium oxide, and cobalt oxide.

In some aspects, the techniques described herein relate to a cementitious material, further including an admixture in an amount of about 0.5% to about 5% of the cementitious material, and wherein the admixture includes pH regulating admixtures, curing enhancers, agglomeration reducers, set retarders, strength enhancers, corrosion inhibitors, shrinkage reducers, crack reducers, viscosity reducer, superplasticizers, air entrainments, or combinations thereof.

In some aspects, the techniques described herein relate to a cementitious material, wherein the cementitious material has a compressive strength of at least 1000 psi when cured.

In some aspects, the techniques described herein relate to a cementitious material, wherein the cementitious material can be cured at a temperature of at least about 23° C. for cast in place or precast applications.

In some aspects, the techniques described herein relate to a method of making a cementitious material including: contacting an industrial byproduct and/or natural material with one or more of a chemical activator or water, mixing the industrial byproduct and/or natural material with one or more of the chemical activator or the water to thereby form a cementitious material, wherein the chemical activator includes one or more of potassium silicates, potassium carbonate, potassium phosphate, potassium bicarbonate, potassium nitrate, potassium hydroxide, potassium oxide, potassium sulfate, sodium silicates, sodium carbonate, sodium phosphate, sodium bicarbonate, sodium nitrate, sodium hydroxide, sodium oxide, sodium sulfate, calcium nitrate, calcium silicates, calcium hydroxide, calcium oxide, calcium aluminates, calcium sulfate, calcium aluminum silicates, calcium silicate hydrates, calcium aluminum silicate hydrates, and wherein the industrial byproduct or natural material includes one or more of ferrous slag, non-ferrous slag, converter steel slag, air-cooled slag, Solvay phosphorous slag, bauxite slag/residue, zinc slag, lead slag, electric arc furnace (EAF) slag, granulated, blast fumace slag, ladle slag, copper slag, mine tales, zeolites, clay, volcanic lava, volcanic tuffs, metakaolin, calcined shale, silica fume gaize, biomass ash, halloysite, calcined clay, basalt, granite, pumice, natural pozzolans, bottom ash, fly ash, cement kiln dust, fine waste glass powder derived from waste glass, mining waste (for example, Belterra clay), a finely ground waste concrete powder derived from construction and demolition waste, or rubble, and EAF dust together with lime kiln dust, or municipal solid waste incineration ash.

In some aspects, the techniques described herein relate to a method, wherein both water and chemical activator are mixed with the industrial byproduct and/or the natural material, and the chemical activator is mixed with the industrial byproduct and/or the natural material before the water is mixed with the industrial byproduct and/or the natural material.

In some aspects, the techniques described herein relate to a method, wherein the mixing is performed by a milling machine.

In some aspects, the techniques described herein relate to a method, wherein the chemical activator is dissolved in water before being mixed with the industrial byproduct and/or natural material.

In some aspects, the techniques described herein relate to a method, further including milling one or more of the industrial byproduct and/or natural material and the chemical activators.

In some aspects, the techniques described herein relate to a method, wherein the milling is performed for up to 50 hours.

In some aspects, the techniques described herein relate to a method, further including mixing one or more of sand, gravel, pH regulating admixtures, curing enhancers, agglomeration reducers, set retarders, strength enhancers, corrosion inhibitors, shrinkage reducers, crack reducers, viscosity reducer, superplasticizers, air entrainments, with the chemical activator and the industrial byproduct and/or natural material.

In some aspects, the techniques described herein relate to a method, wherein the mixing is of less than about 30 wt. % chemical activator.

In some aspects, the techniques described herein relate to a method, wherein the mixing is of less than about 15 wt. % chemical activator.

In some aspects, the techniques described herein relate to a method, wherein the mixing is of less than about 5 wt. % chemical activator.

In some aspects, the techniques described herein relate to a method, further including curing the cementitious material by contacting the cementitious material with moisture.

In some aspects, the techniques described herein relate to a method, wherein the cementitious material is cured at a temperature greater than 0° C.

In some aspects, the techniques described herein relate to a method, wherein the chemical activators are mixed in an amount of at least 0.5 wt. %.

In some aspects, the techniques described herein relate to a method, further including curing the cementitious material at a temperature of at least about 23° C. to form a product for cast in place or precast applications.

In some aspects, the techniques described herein relate to a composite material including the cementitious material and one or more aggregates.

### DETAILED DESCRIPTION

The present disclosure describes cementitious materials containing at least one chemical activator and an industrial byproduct and/or natural material, and methods for making the same. The present compositions may, in some aspects, offer improved performance relative to conventional Portland cement with lower energy required for production and thereby lower environmental costs. The present disclosure describes methods and compositions for improving different properties of chemically activated materials. The activated material composition of the invention may include ferrous slag, non-ferrous slag, converter steel slag, air-cooled slag, Solvay phosphorous slag, bauxite slag/residue, zinc slag, lead slag, electric arc furnace (EAF) slag, granulated, blast furnace slag, ladle slag, copper slag, mine tales, zeolites, clay, volcanic lava, volcanic tuffs, metakaolin, calcined shale, silica fume gauze, biomass ash, halloysite, calcined clay, basalt, granite, pumice, natural pozzolans, bottom ash, fly ash, cement kiln dust, fine waste glass powder derived from waste glass, mining waste (for example, Belterra clay), a finely ground waste concrete powder derived from construction and demolition waste, or rubble, and EAF dust together with lime kiln dust, municipal solid waste incineration ash, limestone, marble, gabbro, or combinations thereof. The present disclosure may include milling which may improve the strength and other properties. The cementitious materials of the present disclosure may also be referred to as binder, chemically activated binders, chemically activated cementitious materials, and the like.

In some embodiments, there is provided a cementitious material which includes a chemical activator and an industrial byproduct and/or natural material. The cementitious material may be a chemically activated cementitious binder. The activator is not limited and may include one or more of potassium silicates, potassium carbonate, potassium phosphate, potassium bicarbonate, potassium nitrate, potassium hydroxide, potassium oxide, potassium sulfate, sodium silicates, sodium carbonate, sodium phosphate, sodium bicarbonate, sodium nitrate, sodium hydroxide, sodium oxide, sodium sulfate, calcium nitrate, calcium silicates, calcium hydroxide, calcium oxide, calcium aluminates, calcium sulfate, calcium aluminum silicates, calcium silicate hydrates, calcium aluminum silicate hydrates or combinations thereof. In some embodiments, the industrial byproduct and/or natural material includes one or more of ferrous slag, non-ferrous slag, converter steel slag, air-cooled slag, Solvay phosphorous slag, bauxite slag/residue, zinc slag, lead slag, electric arc fumace (EAF) slag, granulated, blast furnace slag, ladle slag, copper slag, mine tales, zeolites, clay, volcanic lava, volcanic tuffs, metakaolin, calcined shale, silica fume gauze, biomass ash, halloysite, calcined clay, basalt, granite, pumice, natural pozzolans, bottom ash, fly ash, cement kiln dust, fine waste glass powder derived from waste glass, mining waste (for example, Belterra clay), a finely ground waste concrete powder derived from construction and demolition waste, or rubble, and EAF dust together with lime kiln dust, municipal solid waste incineration ash, limestone, marble, gabbro, or combinations thereof along with various chemical activators mentioned before and admixtures for activation, strength, and durability enhancement, reducing water content, controlling the color, and improving the other properties.

In some aspects, the cementitious material includes the industrial byproduct and/or natural material, the combination of two or more chemical activators and admixtures for activation, strength and durability enhancement, reducing water content, controlling the color, and improving the other properties. In some embodiments, the chemically activated cementitious binder includes the industrial byproduct and/or natural material, a combination of two or more chemical activators and admixtures, milling for a certain period for mechanochemical activation, enhancement of strength and durability, controlling the color, increasing surface area for effective reactions and thereby improving the other properties.

In some embodiments, the cementitious material of the present disclosure is in the form of a paste, such as a binder paste, wherein the components as described herein are mixed with water. The chemically activated cementitious binder as described herein is in some embodiments mixed with water and can be curable at room temperature.

In some embodiments, the cementitious material of the present disclosure is in the form of a paste, such as a binder paste, wherein the components as described herein are mixed with water. The chemically activated cementitious binder as described herein is in some embodiments mixed with water and can be curable at high temperatures, humid conditions, high pressure, or combination thereof to make the precast products. The chemically activated cementitious binder as described herein is in some embodiments sets in a few hours at high temperatures which is ready to be demolded.

In some embodiments, the curing temperature may be about 15° C. to about 100° C. and the curing time may be about 1 hour to about 24 hours for the precast products

In some embodiments, the cementitious material further includes sand, gravel, pH regulating admixtures, curing enhancers, agglomeration reducers, set retarders, strength enhancers, corrosion inhibitors, shrinkage reducers, crack reducers, viscosity reducers, superplasticizers, air entrainments, or combinations thereof. Other additives familiar to those of ordinary skill in the art may also be included.

In some embodiments, the cementitious material as described herein includes a chemical activator, wherein the chemical activator may include various and/or multiple components as described above. The chemical activator may be present in amounts of about 1 wt. % to about 30 wt. % of the mixture and can be selected from one or more chemical activators mentioned before. In some embodiments, cementitious material includes less than about 15 wt. % chemical activator or a combination thereof, such as about 30 wt. %, about 29 wt. %, about 28 wt. %, about 27 wt. %, about 26 wt. %, about 25 wt. %, about 24 wt. %, about 23 wt. %, about 22 wt. %, about 21 wt. %, about 20 wt. %, about 19 wt. %, about 18 wt. %, about 17 wt. %, about 16 wt. % about 15 wt. %, about 14 wt. %, about 13 wt. %, about 12 wt. %, about 11 wt. %, about 10 wt. %, about 9 wt. %, about 8 wt. %, about 7 wt. %, about 6 wt. %, about 5 wt. %, about 4 wt. %, about 3 wt. %, about 2 wt. %, about 1 wt. %, about 0.5 wt. %, or any range or value contained therein. In some embodiments, the remaining weight percentage of the cementitious material is the industrial byproduct and/or natural material and other additives as described herein. In some embodiments, the cementitious material contains at least 80 wt. % or more industrial byproduct and/or natural material and the rest (about 20 wt. % or less) are activators and/or admixtures. In some embodiments, the cementitious material includes a pigment which in some embodiments is present in an amount of about 0.1 to 10 wt. % of the binder and may include iron oxide, cobalt oxide, or chromium oxide pigments. In some embodiments, the cementitious material may include pH regulating admixtures, curing enhancers, agglomeration reducers, set retarders, strength enhancers, corrosion inhibitors, shrinkage reducers, crack reducers, viscosity reducer, air entertainers, plasticizers and superplasticizers, one or more of which are present in an amount of about 0.1 wt. % to about 5 wt. % of the binder.

There is provided a method of making a cementitious material, which includes combining a chemical activator and an industrial byproduct or natural material with water. In some embodiments, a chemical activator may include one or more of potassium silicates, potassium carbonate, potassium phosphate, potassium bicarbonate, potassium nitrate, potassium hydroxide, potassium oxide, potassium sulfate, sodium silicates, sodium carbonate, sodium phosphate, sodium bicarbonate, sodium nitrate, sodium hydroxide, sodium oxide, sodium sulfate, calcium nitrate, calcium silicates, calcium hydroxide, calcium oxide, calcium aluminates, calcium sulfate, calcium aluminum silicates, calcium silicate hydrates, calcium aluminum silicate hydrates or combinations thereof. In some embodiments, the industrial byproduct and/or natural material includes one or more of ferrous slag, non-ferrous slag, converter steel slag, air-cooled slag, Solvay phosphorous slag, bauxite slag/residue, zinc slag, lead slag, electric arc furnace (EAF) slag, granulated, blast fumace slag, ladle slag, copper slag, mine tales, zeolites, clay, volcanic lava, volcanic tuffs, metakaolin, calcined shale, silica fume gauze, biomass ash, halloysite, calcined clay, basalt, granite, pumice, natural pozzolans, bottom ash, fly ash, cement kiln dust, fine waste glass powder derived from waste glass, mining waste (for example, Belterra clay), a finely ground waste concrete powder derived from construction and demolition waste, or rubble, and EAF dust together with lime kiln dust, municipal solid waste incineration ash, limestone, marble, gabbro, or combinations thereof. The source and particular composition of the industrial byproducts and/or natural materials is not particularly limited. The combination of a chemical activator and the industrial byproduct and/or natural material with water may form a binder paste and result in the activation of the industrial byproduct and/or natural material.

In some embodiments, the chemical activator and the industrial byproduct and/or natural material are mixed before being combined with water. In some embodiments, the chemical activator and the industrial byproduct and/or natural material may be mixed in a milling machine or ball mill such that they are mixed dry. Without wishing to be bound by theory, mixing the chemical activator and the industrial byproduct and/or natural material may result in mechanochemical activation of the industrial byproduct, followed by the addition of water to form a binder paste. In some embodiments, the chemically activated material mixture is milled between about 0.1 to about 10 hours, about 1 to about 10 hours, about 1 to about 20 hours, about 1 to about 40 hours, about 1 to about 50 hours, and about 1 to about 100 hours.

In some embodiments, the chemical activator is dissolved in water, which is in some embodiments hot water, before being combined with the industrial byproduct and/or natural material. The chemical activator which is dissolved in water may then be combined with the industrial byproduct and/or natural material.

In some embodiments, the cementitious material described herein and made by the methods described herein is used directly as a cementitious material in any manner familiar to those skilled in the art, such as for example to form concrete. In other embodiments, the cementitious material of the present disclosure is combined with Portland cement or other cementitious material prior to use. The cementitious material of any embodiment as described herein may be used in cast-in-place or precast construction applications.

In some embodiments, the cementitious material offers improved performance relative to Portland cement. Improved performance is not limited and may refer to increased strength, increased durability, reduced water content, low or reduced heat of hydration, control of color, or combinations thereof. The cementitious material of the present disclosure may be more environmentally friendly and less expensive than traditional Portland cement.

Provided herein are chemically activated material compositions, such as chemically activated cementitious materials and chemically activated cementitious binders, which contain one or more admixtures. Also disclosed are preparation methods for chemically activated materials that contain one or more admixtures. The chemical activators and admixtures described herein activate the reactions and improve one or more properties of chemically activated binders, without wishing to be bound by theory. The milling for different durations also may improve one or more properties of the chemically activated materials. In one embodiment the size of chemical activators or admixtures can be coarse, fine, and ultra-fine.

In some embodiments, there is provided a chemically activated cementitious binder material which includes a base material such as industrial byproduct and/or natural material which is activated with one or more chemical activators, wherein the activators can include potassium silicates, potassium carbonate, potassium phosphate, potassium bicarbonate, potassium nitrate, potassium hydroxide, potassium oxide, potassium sulfate, sodium silicates, sodium carbonate, sodium phosphate, sodium bicarbonate, sodium nitrate, sodium hydroxide, sodium oxide, sodium sulfate, calcium nitrate, calcium silicates, calcium hydroxide, calcium oxide, calcium aluminates, calcium sulfate, calcium aluminum silicates, calcium silicate hydrates, calcium aluminum silicate hydrates or combinations thereof; and a combination of one or more admixtures including pigment admixtures, pH regulating admixtures, curing enhancers, agglomeration reducers, set retarders, strength enhancers, corrosion inhibitors, shrinkage reducers, crack reducers, viscosity reducer, air entertainers, water reducing admixtures, plasticizers and superplasticizers, or combinations thereof.

The chemically activated cementitious binder material of the present disclosure may contain industrial byproduct and/or natural material which has a mean particle size of about 1 um to about 10 um, about 1 um to about 20 um, about 1 um to about 50 um, about 1 um to about 100 um, about 1 um to about 150 um, or about 1 um to about 200 um. The admixtures described herein may have a mean particle size of about 1 um to about 10 um, about 1 um to about 20 um, about 1 um to about 50 um, about 1 um to about 100 um, about 1 um to about 150 um, and about 1 um to about 200 um. Admixtures are mixed with materials either as a solid or half solid and half dissolved or completely dissolved in water.

In some embodiments, the chemically activated cementitious binder material contains a chemical activator or combinations of two or more chemical activators, which can include compounds such as potassium silicates, potassium carbonate, potassium phosphate, potassium bicarbonate, potassium nitrate, potassium hydroxide, potassium oxide, potassium sulfate, sodium silicates, sodium carbonate, sodium phosphate, sodium bicarbonate, sodium nitrate, sodium hydroxide, sodium oxide, sodium sulfate, calcium nitrate, calcium silicates, calcium hydroxide, calcium oxide, calcium aluminates, calcium sulfate, calcium aluminum silicates, calcium silicate hydrates, calcium aluminum silicate hydrates or combinations thereof.

In certain embodiments, the mass ratio of base material (for example, slag or any industrial byproduct and/or natural material as described herein) to chemical activator is more than 4.0, such as from about 5 to about 99. In certain embodiments, this ratio is about from 5 to 99. In certain embodiments, this ratio is about from 5 to 50. In certain embodiments, this ratio is from 5 to 10.

In certain embodiments, the mass ratio of one chemical activator to another is more than 1, such as from about 1 to 20. In certain embodiments, this ratio is about from 1 to 10. In certain embodiments, this ratio is about from 1 to 5. In certain embodiments, this ratio is about from 1 to 4.5. In certain embodiments, this ratio is about from 1 to 3.5. In certain embodiments, this ratio is about from 1 to 2.5. In certain embodiments, this ratio is about from 1 to 2. In certain embodiments, this ratio is about from 1 to 1.5. In certain embodiments, this ratio is about from 1 to 1.25. In certain embodiments, this ratio is about from 1 to 1.

In one embodiment, the chemically activated material contains admixtures that are one or more pigments evenly or unevenly dispersed in bonding matrices. The pigment can be any suitable pigment of various metal oxide salts such as red iron oxide, black iron oxide, chromium oxide, and cobalt oxide. The pigment can be any color including black, grey, white, blue, green, red, yellow, and brown.

In certain embodiments, the mass ratio of chemical activators to pigment admixture is more than 1, such as from about 1 to 2. In certain embodiments, this ratio is about from 1 to 5. In certain embodiments, this ratio is about from 1 to 10. In certain embodiments, this ratio is about from 1 to 20.

In some embodiments, the chemically activated cementitious binder material may contain a curing enhancer admixture in an amount of about 0.1 wt. % to about 5 wt. %. In certain embodiments, the amount is about 0.1 wt. % to about 4 wt. %. In certain embodiments, the amount is about 0.1% to about 3%. In certain embodiments, the amount is about 0.1% to about 3%. In certain embodiments, the amount is about 0.1% to about 2%. In certain embodiments, the amount is about 0.1% to about 1%. In certain embodiments, the amount is about 0.1% to about 0.5%.

In some embodiments, the chemically activated cementitious binder material may contain a agglomeration reducers admixture in an amount of about 0.1 wt. % to about 5 wt. %. In certain embodiments, the amount is about 0.1 wt. % to about 4 wt. %. In certain embodiments, the amount is about 0.1 wt. % to about 3 wt. %. In certain embodiments, the amount is about 0.1 wt. % to about 3 wt. %. In certain embodiments, the amount is about 0.1 wt. % to about 2 wt. %. In certain embodiments, the amount is about 0.1 wt. % to about 1 wt. %. In certain embodiments, the amount is about 0.1 wt. % to about 0.5 wt. %.

In some embodiments, the chemically activated cementitious binder material may contain a strength enhancer admixture in an amount of about 0.1 wt. % to about 5 wt. %. In certain embodiments, the amount is about 0.1 wt. % to about 4 wt. %. In certain embodiments, the amount is about 0. wt. 1% to about 3 wt. %. In certain embodiments, the amount is about 0.1 wt. % to about 3 wt. %. In certain embodiments, the amount is about 0.1 wt. % to about 2 wt. %. In certain embodiments, the amount is about 0.1 wt. % to about 1 wt. %. In certain embodiments, the amount is about 0.1 wt. % to about 0.5 wt. %.

In some embodiments, the chemically activated cementitious binder material may contain a set retarder admixture in an amount of about 0.1 wt. % to about 5 wt. %. In certain embodiments, the amount is about 0.1 wt. % to about 4 wt. %. In certain embodiments, the amount is about 0.1 wt. % to about 3 wt. %. In certain embodiments, the amount is about 0.1 wt. % to about 3 wt. %. In certain embodiments, the amount is about 0.1 wt. % to about 2 wt. %. In certain embodiments, the amount is about 0.1 wt. % to about 1 wt. %. In certain embodiments, the amount is about 0.1 wt. % to about 0.5 wt. %.

In some embodiments, the chemically activated cementitious binder material may contain a shrinkage reducer admixture in an amount of about 0.1 wt. % to about 5 wt. %. In certain embodiments, the amount is about 0.1 wt. % to about 4 wt. %. In certain embodiments, the amount is about 0.1 wt. % to about 3 wt. %. In certain embodiments, the amount is about 0.1 wt. % to about 3 wt. %. In certain embodiments, the amount is about 0.1 wt. % to about 2 wt. %. In certain embodiments, the amount is about 0.1 wt. % to about 1 wt. %. In certain embodiments, the amount is about 0.1 wt. % to about 0.5 wt. %.

In some embodiments, the chemically activated cementitious binder material may contain a crack reducer admixture in an amount of about 0.1 wt. % to about 5 wt. %. In certain embodiments, the amount is about 0.1 wt. % to about 4 wt. %. In certain embodiments, the amount is about 0.1 wt. % to about 3 wt. %. In certain embodiments, the amount is about 0.1 wt. % to about 3 wt. %. In certain embodiments, the amount is about 0.1 wt. % to about 2 wt. %. In certain embodiments, the amount is about 0.1 wt. % to about 1 wt. %. In certain embodiments, the amount is about 0.1 wt. % to about 0.5 wt. %.

In some embodiments, the chemically activated cementitious binder material may contain a viscosity reducer admixture in an amount of about 0.1 wt. % to about 5 wt. %. In certain embodiments, the amount is about 0.1 wt. % to about 4 wt. %. In certain embodiments, the amount is about 0.1 wt. % to about 3 wt. %. In certain embodiments, the amount is about 0.1 wt. % to about 3 wt. %. In certain embodiments, the amount is about 0.1 wt. % to about 2 wt. %. In certain embodiments, the amount is about 0.1 wt. % to about 1 wt. %. In certain embodiments, the amount is about 0.1 wt. % to about 0.5 wt. %.

In some embodiments, the chemically activated cementitious binder material may contain a water-reducing admixture (plasticizer and superplasticizer). The efficiency of the plasticizer and superplasticizer can be evaluated according to the water-reducing capacity in the binder mixture while keeping the same consistency.

In certain embodiments, the chemically activated cementitious binder material includes at least 0.5 wt. % of the one or more chemical activators. In certain embodiments, the activated cementitious binder material includes a pigment admixture in an amount of about 0.1 wt. % to about 3 wt. % of the activated material, wherein the pigment admixture includes red iron oxide, black iron oxide, chromium oxide, and cobalt oxide.

In some embodiments, the base material is premixed in water and subsequently added to the one or more chemical activators and mixed, or one or more chemical activators are premixed in water and then added to the base material and mixed, or one or more chemical activator and the base material are added together and then mixed with water.

In some embodiments, one or more of the base materials, one or more chemical activators, or combinations thereof are milled.

In certain embodiments, the milling time of the mixture is about 0-5 hours. In certain embodiments, the milling time of the mixture is about 0-10 hours. In certain embodiments, the milling time of the mixture is about 0-20 hours. In certain embodiments, the milling time of the mixture is about 0-30 hours. In certain embodiments, the milling time of the mixture is about 0-40 hours. In certain embodiments, the milling time of the mixture is about 0-50 hours.

Any suitable aggregates can be used to form composite material from the chemically activated cementitious binder material, such as construction sand or gravel, trap rocks, industrial waste, and other types of fillers. The mean particle size of the aggregate can range from about 0.1 to about 30 mm. In certain embodiments, the mean particle size of aggregate can range from about 0.1 to about 15 mm or about 0.1 mm to about 10 mm or about 0.1 mm to about 5 mm or about 0.1 to about 1 mm.

Provided herein are methods to improve one or more properties of chemically activated cementitious binder materials, including by adding various chemical activators and/or admixtures to the binder composition, and/or by milling the chemically activated cementitious binder mixture. In some embodiments, adding to a base material (for example, any industrial byproduct and/or natural material as described herein) a chemical activator comprises adding a solid chemical activator. In some embodiments, adding to the base material a chemical activator comprises adding a liquid chemical activator. In some embodiments, adding to the base material a chemical activator comprises adding a mixture of solid and liquid chemical activators. In some embodiments, adding to the base material an admixture comprises adding a solid admixture. In some embodiments, adding to the base material an admixture comprises adding a liquid admixture. In some embodiments, adding to the base material an admixture comprises adding a mixture of liquid and solid admixtures. In some embodiments, the mixture of the base material such as industrial byproduct and/or natural material, chemical activator, and admixture can be all milled. The methods provided herein can include a curing step to form a concrete product. In some embodiments, the chemically activated cementitious binder material has a compressive strength of at least 1000 psi when cured. In some embodiments, the chemically activated cementitious binder material is curable at a temperature of more than about 0° C. In some embodiments, the chemically activated cementitious binder material can be curable at normal or humid conditions, room temperature or high temperature, or combination thereof.

In some embodiments, when more than one chemical activator is added, the activators can be added in any or order. In certain embodiments, two or more chemical activators can be added together as a mixture.

Provided herein are methods to improve one or more strength properties of chemically activated cementitious binder material (relative to traditional materials) by adding a chemical activator and/or admixtures, and/or milling. Examples of strength properties that can be improved include compressive strength, torsional strength, split tensile strength, tensile strength, flexural strength and combinations thereof.

Provided herein are methods to control the color of the concrete product by adding different admixtures. In some examples, a pigment admixture as described herein is added.

In some embodiments, activation of the base material (the industrial byproduct and/or natural material) as described herein may result in the formation of one or more phases of geopolymers such as calcium (alumino) silica hydrates (CASH), sodium (alumino) silica hydrates (NASH), or calcium-silicate-hydrate (C-S-H), carbonates or combinations thereof.

The embodiments described herein may be combined in any fashion to form new embodiments.

This disclosure is not limited to the particular systems, devices, and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55%. The ranges disclosed here includes the upper and lower limits.

As used herein, the terms “cementitious material”, “chemically activated cementitious material”, “chemically activated admixture”, “chemically activated material”, “chemically activated cementitious binder” and the like may be used to refer to the compositions described herein or precursors thereto.

As used herein, the terms “base material”, “industrial byproduct”, “natural material”, “slag”, and the like refer to the same general starting material which is activated by the chemical activators described herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

1. A cementitious material comprising:
a chemical activator that includes one or more of potassium silicates, potassium carbonate, potassium phosphate, potassium bicarbonate, potassium nitrate, potassium hydroxide, potassium oxide, potassium sulfate, sodium silicates, sodium carbonate, sodium phosphate, sodium bicarbonate, sodium nitrate, sodium hydroxide, sodium oxide, sodium sulfate, calcium nitrate, calcium silicates, calcium hydroxide, calcium oxide, calcium aluminates, calcium sulfate, calcium aluminum silicates, calcium silicate hydrates, calcium aluminum silicate hydrates; and
an industrial byproduct and/or natural material that includes one or more of ferrous slag, non-ferrous slag, converter steel slag, air-cooled slag, Solvay phosphorous slag, bauxite slag/residue, zinc slag, lead slag, electric arc furnace (EAF) slag, granulated, blast furnace slag, ladle slag, copper slag, mine tales, zeolites, clay, volcanic lava, volcanic tuffs, metakaolin, calcined shale, silica fume gaize, biomass ash, halloysite, calcined clay, basalt, granite, pumice, natural pozzolans, bottom ash, fly ash, cement kiln dust, fine waste glass powder derived from waste glass, mining waste (for example, Belterra clay), a finely ground waste concrete powder derived from construction and demolition waste, or rubble, and EAF dust together with lime kiln dust, or municipal solid waste incineration ash.

2. The cementitious material of claim 1, further comprising one or more of sand, gravel, pH regulating admixtures, curing enhancers, agglomeration reducers, set retarders, strength enhancers, corrosion inhibitors, shrinkage reducers, crack reducers, viscosity reducer, superplasticizers, air entrainments, or combinations thereof.

3. The cementitious material of claim 1, wherein the cementitious material comprises less than about 30 wt. % of the chemical activator.

4. The cementitious material of claim 1, wherein the cementitious material comprises less than about 15 wt. % of the chemical activator.

5. The cementitious material of claim 1, wherein the cementitious material comprises less than about 10 wt. % of the chemical activator.

6. The cementitious material of claim 1, wherein the cementitious material comprises less than about 5 wt. % of the chemical activator.

7. The cementitious material of claim 1, further comprising a pigment admixture in an amount of about 0.1 wt. % to about 3 wt. % of the cementitious material, wherein the pigment admixture contains one or more of red iron oxide, black iron oxide, chromium oxide, and cobalt oxide.

8. The cementitious material of claim 1, further comprising an admixture in an amount of about 0.5% to about 5% of the cementitious material, and wherein the admixture comprises pH regulating admixtures, curing enhancers, agglomeration reducers, set retarders, strength enhancers, corrosion inhibitors, shrinkage reducers, crack reducers, viscosity reducer, superplasticizers, air entrainments, or combinations thereof.

9. The cementitious material of claim 1, wherein the cementitious material has a compressive strength of at least 1000 psi when cured.

10. The cementitious material of claim 1, wherein the cementitious material can be cured at a temperature of at least about 23° C. for cast in place or precast applications.

11. A method of making a cementitious material comprising:
contacting an industrial byproduct and/or natural material with one or more of a chemical activator or water,
mixing the industrial byproduct and/or natural material with one or more of the chemical activator or the water to thereby form a cementitious material,
wherein the chemical activator includes one or more of potassium silicates, potassium carbonate, potassium phosphate, potassium bicarbonate, potassium nitrate, potassium hydroxide, potassium oxide, potassium sulfate, sodium silicates, sodium carbonate, sodium phosphate, sodium bicarbonate, sodium nitrate, sodium hydroxide, sodium oxide, sodium sulfate, calcium nitrate, calcium silicates, calcium hydroxide, calcium oxide, calcium aluminates, calcium sulfate, calcium aluminum silicates, calcium silicate hydrates, calcium aluminum silicate hydrates, and
wherein the industrial byproduct or natural material includes one or more of ferrous slag, non-ferrous slag, converter steel slag, air-cooled slag, Solvay phosphorous slag, bauxite slag/residue, zinc slag, lead slag, electric arc furnace (EAF) slag, granulated, blast furnace slag, ladle slag, copper slag, mine tales, zeolites, clay, volcanic lava, volcanic tuffs, metakaolin, calcined shale, silica fume gaize, biomass ash, halloysite, calcined clay, basalt, granite, pumice, natural pozzolans, bottom ash, fly ash, cement kiln dust, fine waste glass powder derived from waste glass, mining waste (for example, Belterra clay), a finely ground waste concrete powder derived from construction and demolition waste, or rubble, and EAF dust together with lime kiln dust, or municipal solid waste incineration ash.

12. The method of claim 11, wherein both water and chemical activator are mixed with the industrial byproduct and/or the natural material, and the chemical activator is mixed with the industrial byproduct and/or the natural material before the water is mixed with the industrial byproduct and/or the natural material.

13. The method of claim 12, wherein the mixing is performed by a milling machine.

14. The method of claim 11, wherein the chemical activator is dissolved in water before being mixed with the industrial byproduct and/or natural material.

15. The method of claim 11, further comprising milling one or more of the industrial byproduct and/or natural material and the chemical activators.

16. The method of claim 15, wherein the milling is performed for up to 50 hours.

17. The method of claim 11, further comprising mixing one or more of sand, gravel, pH regulating admixtures, curing enhancers, agglomeration reducers, set retarders, strength enhancers, corrosion inhibitors, shrinkage reducers, crack reducers, viscosity reducer, superplasticizers, air entrainments, with the chemical activator and the industrial byproduct and/or natural material.

18. The method of claim 11, wherein the mixing is of less than about 30 wt. % chemical activator.

19. The method of claim 11, wherein the mixing is of less than about 15 wt. % chemical activator.

20. The method of claim 11, wherein the mixing is of less than about 5 wt. % chemical activator.

21. The method of claim 11, further comprising curing the cementitious material by contacting the cementitious material with moisture.

22. The method of claim 21, wherein the cementitious material is cured at a temperature greater than 0° C.

23. The method of claim 11, wherein the chemical activators are mixed in an amount of at least 0.5 wt. %.

24. The method of claim 11, further comprising curing the cementitious material at a temperature of at least about 23° C. to form a product for cast in place or precast applications.

25. A composite material comprising the cementitious material of any of claim 1 and one or more aggregates.
